(19) United States
(12) Patent Application Publication
(10) Pub. No.: US 2006/0131770 A1
(43) Pub. Date: Jun. 22, 2006

(54) Process for the production of a dental model, a dental model with a ceramic layer deposited thereon and a dental moulding, dental model,,and use of 3D printer and a kit

(75) Inventors: Stephan Dierkes, Bremen (DE); Thomas Wiest, Hunfeld (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: BEGO Bremer Goldschlagerei Wilh Herbst GmbH & KG

(21) Appl. No.: 11/260,304

(22) Filed: Oct. 28, 2005

(30) Foreign Application Priority Data
Oct. 28, 2004 (DE) 102004052364.9-23

(51) Int. Cl. A61C 13/00; B29C 35/08; B29C 41/02

(52) U.S. Cl. 264/16; 264/308; 264/401; 264/104; 264/105

(57) ABSTRACT

The invention relates to a process for the production of a dental model (24). The invention furthermore relates to a dental model which can be produced in this way, optionally with a ceramic layer deposited thereon, a process for the production of a dental moulding, the use of a 3D printer and the use of a kit.

According to the invention, the following steps are proposed for the process: (a) provision of one or more fluid, solidifiable materials and one or more electrically conductive substances and (b) production of the dental model (24) by rapid prototyping using the fluid, solidifiable material or materials and the one or more electrically conductive substances, so that the dental model produced is electrically conductive in one or more areas (26, 28, 30) of its surface.

This application claims priority to German Patent Application Serial No. 10 2004 052 364.9-23, filed on Oct. 28, 2004, the contents of which are herein incorporated by reference.

### FIELD OF THE INVENTION

The invention relates to a process for the production of a dental model. The invention furthermore relates to a dental model comprising one or more solidified materials and one or more electrically conductive substances in one or more areas of its surface. The invention additionally relates to a process for the production of a dental model with a ceramic layer deposited thereon, and to a process for the production of a dental moulding. Finally, the invention includes the use of a 3D printer having one, two or more print systems, and to the use of a kit.

### BACKGROUND

It is known to produce dental models by casting from an impression. For this, an impression of the oral cavity of the patient is first taken by means of a curable moulding composition. This impression is then filled with gypsum, and a so-called master model is produced from this impression. A working model which serves as a template for a dental restoration, that is to say the dental prosthesis, to be produced is conventionally produced by so-called duplication by means of this master model.

The conventional dental prosthesis has hitherto as a rule been made in the dental laboratory with a high proportion of manual work. In addition to completely metal and completely ceramic restorations, a material composite of metal and ceramic prevails above all. Such a metal/ceramic crown or bridge comprises a metallic matrix and a so-called veneer which matches the tooth and comprises one or more layers of a dental ceramic. The cap is produced such that it can be joined to the remaining tooth stump or to any implant in the patient. The metals employed in the production of the cap have disadvantages. Thus, they can lead to changes in colour due to corrosion phenomena, and also to physical intolerances.

For this reason, completely ceramic restorations in which the matrix is also made of a ceramic are employed. Ceramics which can be particularly subjected to mechanical stresses are chosen for this. In recent years, processes have increasingly been developed for the production and shaping of such completely ceramic restorations, since ceramic is a chemically resistant, corrosion-resistant and biocompatible material. For the production of ceramic dental restorations, such as crown and bridge matrices, in addition to the known crafted production methods of applying a slip of a ceramic layer by means of a brush, the semi-automated process of defined destabilization of a slip with milling, an industrial production process has developed.

In parallel with this, there are developments to establish the known ceramic layer formation process, that is to say the build-up process of electrophoretic deposition, in the dental sector. In this context, a ceramic slip is deposited on a model. The solid content of a ceramic slip is applied to or deposited on a positive model of a tooth stump. There are various systems for the material and the formation of this model. Thus, in the patent DE 101 15 820 A1 a positive is produced from a wax, which expands during heat treatment, via casting in a negative mould

In order to accelerate the production of ceramic caps, and also of completely ceramic dental mouldings, and to save on human workforce, DE 101 15 820 A1 proposes initial production of a set of data by digital scanning. The corresponding dental model is then produced from this set of data by polymerizing a plastics monomer solution with laser light (stereolithography). In another case, the set of data is used to produce a corresponding model via milling of gypsum. A silver lacquer is then applied manually to parts of the surface, and these are thus rendered conductive. The conductive parts of the surface of the dental model are subsequently contacted electrically. Ceramic powder dispersed in liquid is then deposited on the dental model with the aid of an electrical field. The ceramic body obtained in this manner is finally subjected to dense sintering to give a ceramic matrix. Alternatively, but also in addition, it is first superficially sintered without a change in geometry.

A disadvantage of this process is that there is no closed production chain which proceeds without human intervention. Thus, the dental model obtained by laser polymerization or milling of gypsum must be removed from the corresponding apparatus and brushed manually with conductive silver lacquer. The dental model prepared in this way must then be prepared for electrophoretic deposition of a slip.

### SUMMARY OF THE INVENTION

It is an object of the present invention to render such human interventions superfluous or at least to reduce them significantly.

According to a first aspect, the object is achieved by a process for the production of a dental model with the following steps:
provision of one or more fluid, solidifiable materials (preferably having a melting point of below 250° C.) and of one or more electrically conductive substances and
production of the dental model by rapid prototyping using the fluid, solidifiable material or the fluid, solidifiable materials (preferably having a melting point of below 250° C.) and the one or more electrically conductive substances, so that the dental model produced (with solidified material) is now electrically conductive in one or more areas of its surface.

According to a second aspect, the object is achieved by a dental model of the present invention, which can be produced by a process according to the invention described herein.

According to a third aspect, the object is achieved by a process for the production of a dental model with a ceramic layer deposited thereon, with the following steps:
production of a model which is electrically conductive in one or more areas of its surface by rapid prototyping in a rapid prototyping process according to the invention (preferably in a preferred embodiment),
electrophoretic and/or electrolytic deposition of a ceramic layer on one or more electrically conductive areas of the surface of the model produced.

According to a fourth aspect, the object is achieved by a process for the production of a dental moulding with the following steps:
production of a dental model with a ceramic layer deposited thereon by a process according to the invention (preferably in a preferred embodiment, see below),
working of the dental model with the ceramic layer deposited thereon, so that the ceramic layer is converted into a dental moulding.

According to a fifth aspect, the object is achieved by the use of a 3D printer having one, two or more print systems for printing out a dental model which comprises one or more solidified materials and which comprises one or more electrically conductive substances in one or more areas of its surface.

According to a sixth aspect, the object is achieved by the use of a kit comprising (a) a first cartridge containing one or more fluid, solidifiable or fluidizable and re-solidifiable materials, and (b) a second cartridge containing one or more electrically conductive substances, the kit being adapted for use in a rapid prototyping process according to the invention (preferably in a preferred embodiment).

One advantage of the invention (in its various aspects) is that human workforce can be saved. Thus, the dental model is already conductive, and can easily be contacted with electrodes.

A further advantage is that no additional layers, such as, for example, graphite lacquer or silver lacquer, have to be applied to the dental model, so that no subsequent changes in the geometry of the dental model occur.

In addition, production by rapid prototyping can be carried out very rapidly, so that the patient's waiting time for the dental restoration can be reduced significantly. In spite of the high speed, high accuracies can be achieved with rapid prototyping. High dimensional accuracies are correspondingly achieved in the end product, that is to say the dental restoration or the dental moulding, which increases the wearing comfort for the patient.

Finally, the substances used are inexpensive, and rapid prototyping processes are easy to control, which results in a high process stability.

Electrically conductive substances are understood as meaning substances which have a specific electrical resistance of less than 5×10² Ωm. One or more of the electrically conductive substances to be employed can be identical to one or more of the fluid, solidifiable materials to be employed. However, this is not always the case. A first fluid, solidifiable material may be employed that uses the same base material as a second fluid, solidifiable material containing an electrically conductive material (i.e., both compositions use the same wax or plastic base material, but the second composition also includes electrically conductive material dispersed therein), or the first and second fluid, solidifiable materials may have different base materials.

An electrically conductive area of the surface of the rapid prototyping model is understood as meaning a demarcated spatial area which comprises the mixture or material which originates from the mixture by solidification, and which has a specific electrical resistance of less than 5×10² Ωm. Particles of electrically conductive substance alone, therefore, do not form a conductive area of the surface. Substances are understood as meaning compositions which have a specific electrical resistance of less than 5×10² Ωm.

Fluid materials are understood as meaning materials which have a viscosity of less than 1,000 Pa·s at a given temperature and under a given pressure. Fluid materials are solidifiable, in particular, if they can be converted into the solid state by cooling, evaporation of a volatile constituent, polymerization, photocuring, setting or crosslinking.

In particular, substances which are solid at 20° C. under 1,013 hPa and have a viscosity of less than 10 Pa·s at elevated temperature (e.g. in the range from 50° C. to 250° C.) under 1,013 hPa belong to the fluid, solidifiable materials at this temperature and under this pressure. Such materials re-solidify on cooling and are well-suited for use in the present invention.

In the case of materials which have no defined melting point (e.g. multi-phase substances), that temperature at which the viscosity of the material under 1,013 hPa falls below 10 Pa·s is regarded as the melting point. In providing the fluid, solidifiable material or materials, solid or fluidizable, resolidifiable materials can be used as the starting materials which are fluidized.

Processes which produce, from data stored in a computer which describe the geometry of a component, a component having the same geometric dimensions without human intervention in respect of shaping being necessary are regarded as rapid prototyping.

A distinction may be made between subtractive and additive rapid prototyping. In subtractive rapid prototyping, material is removed from the solid material. This is as a rule effected by removal of material, such as grinding or milling. In additive rapid prototyping, on the other hand, material is deposited on the workpiece forming, in this case, the dental model.

In preferred processes, one or more additives are also added to the mixture. Thus, a dispersing auxiliary which effects homogenizing and stabilizing of the particles via electrostatic and/or steric interaction can be added to the mixture. The addition of a wetting agent which renders possible the addition of the powder in the fluid having a high surface tension can moreover be envisaged. Materials which serve as thickeners or diluents of the mixture can also be used.

In the context of the present invention, a preferred process is one in which the dental model is produced by additive rapid prototyping. Preferred forms of additive rapid prototyping are 3D printing, in particular inkjet printing, stereolithography and fused deposition modelling (FDM). In the inkjet process', small beads of material are released in liquid form from a print head, and settle on the model being formed and solidify there. In fused deposition modelling, a continuous filament of plastic or wax is softened/melted and positioned (resolidified). Production of components via stereolithography is carried out, for example, via application of a photopolymer in layers and subsequent selective crosslinking of the polymer by means of UV light. lnkjet printing is a process in which previously heated wax or plastic (such as a thermoplastic) or a photopolymer resin leaves the 3D printer in liquid form and solidifies on the component. Inkjet printing can be differentiated by the number of jets from which material is released. Thus, for example, the apparatuses from Solidscape Inc., U.S.A. and BPM Technology operate with one jet (single jet, ballistic particle manufacturing) and wax and thermoplastic as the materials, whereas the inkjet printers from 3D-Systems and from Objet Geometries Ltd. are equipped with several jets (multi-jet modelling, poly-jet) and operate with wax and/or photopolymer resin as the materials. The systems which operate with several jets lead to significantly faster production of models.

The companies already mentioned each offer apparatuses which are equipped with two or more print heads. This allows rapid prototyping models to be built up from several substances simultaneously or successively in layers. Thus in practice, for example, support structures to assist in undercuts are built up with a further material which differs in its physical properties from the material otherwise used.

Preferably, the fluid, solidifiable base material is chosen from the group consisting of wax and plastic (thermoplastic). If the dental model is produced on the basis of a material of fluid, solidifiable wax or plastic having a melting point or melting range of below 250° C., a slip layer deposited on the dental model can easily be removed by melting out before or during an optional subsequent sintering process. Residues of wax or plastic which have not been completely removed during melting out can as a rule be burned without residue.

In the case where the material has no melting point or melting range, dissolving out takes place by decomposition when the decomposition temperature is reached. However, the model can also be dissolved out of the matrix, for example, by superficial dissolving (etching).

Preferably, graphite, carbon black and/or metal particles, in particular silver particles, are used as electrically conductive substances.

In a preferred process, at least one electrically conductive substance is mixed with at least one fluid, solidifiable material before use thereof in rapid prototyping.

In an alternative preferred process, an electrically conductive substance which is simultaneously fluid and solidifiable is employed.

If inkjet printing with two or more print heads is employed, it is advantageous to provide at least one print head with an electrically non-conductive first composition and one print head with an electrically conductive second composition. Areas of the dental model which are to be electrically non-conductive are then produced from the non-conductive fluid, solidifiable material (having a melting point of <250° C.), while electrically conductive areas are produced from the electrically conductive, fluid, solidifiable material.

A preferred process is one in which the dental model produced is electrically conductive in at least two areas of its surface which are electrically insulated from one another. Two points then belong to the same electrically conductive area of the surface if an electrical potential cannot be applied to the one point without the other likewise being at the same electrical potential. If a potential is applied at one electrically conductive point of the surface, all the points which lie at the same electrical potential consequently belong to the same electrically conductive area. Two regions are regarded as electrically insulated from one another if the resistance between the two is greater than 100 kΩ.

A preferred process is one in which at least one electrically conductive substance is a second fluid, solidifiable material that is electrically conductive and may have the same or different base composition as the first fluid, solidifiable material used in the present process.

In an advantageous embodiment, geometric data of the dental model (data model) which are obtained by (a) intraoral scanning or (b) by scanning a master model are used for the rapid prototyping. A master model is understood as meaning the first positive impression. This is as a rule formed by casting from the negative, which is taken in the patient's mouth. Alternatively, the geometric data can also be obtained (c) by scanning a working model. A working model is formed by taking a cast from a master model or another working model.

In a preferred process, the data model is modified before production of the dental model such that an over-dimensioned dental model results, in order to compensate for the change in dimensions to be expected on a dental moulding blank formed by casting from the dental model during its production process.

The dental model (corresponding to the use of a working model in processes according to the prior art) is used to form the actual dental restoration, for example the ceramic cap or the veneer, thereon. In the further processing of the ceramic cap, so-called sinter shrinkage regularly occurs during sintering, i.e. the geometric dimensions of the ceramic cap formed decrease during sintering. Such a sinter shrinkage can already be calculated with the aid of the data model before production of the dental model. The data model is then modified such that, for example, a ceramic cap produced with the aid of this data model has the originally intended geometric dimensions in spite of sinter shrinkage. Any anisotropic sinter shrinkage can also be compensated by suitable simulation.

In an advantageous embodiment of the process according to the invention, before creation of the dental model the data model is modified on the basis of a numerical calculation of the local failure probability of a dental moulding blank formed by casting from the dental model, in particular by an FEM simulation, such that a preselected local failure probability is exceeded nowhere on the dental moulding blank formed. A ceramic cap produced with the aid of the dental model is in fact exposed to high stresses in use, i.e. after insertion into the patient's dentition. These include the mechanical stress from chewing and stresses due to changes in temperature. To ensure the longest possible life of the ceramic cap, the stress acting on this is simulated on a computer. The finite element method (FEM), the finite volume method (FVM) or a similar mathematical method can be employed, for example, for the simulation.

With the aid of this simulation, it is ascertained at what points on the ceramic cap a particularly high stress is to be expected. An increased failure probability is then to be expected at these points if an appropriate material thickness is not used. Locations where failure of the ceramic cap is most probable are thus first identified by simulation calculation. The data model is then modified such that a ceramic cap produced with its aid (by casting from the model obtained from the data model) has a lower failure probability at the corresponding points. If appropriate, the steps of simulation and adjustment are carried out several times.

In a preferred embodiment, before production of the dental model the data model is modified such that a dental model results which (i) has a projection, in particular a projection made of insulating material, at a point which corresponds to a point at which the dental model has a preparation edge and/or (ii) has one or more recesses for accommodation of fixing means for fixing the dental model to a model support.

The preparation edge is the border of the dental moulding, that is to say, in particular, of a cap or a veneer, which lies in the immediate vicinity of the gum, and may be adjacent to this, in the patient's dentition. Because of this proximity to the gum, the preparation edge must be prepared with precision. By providing a projection, the zone in which slip may be deposited in a subsequent working operation is demarcated such that a defined preparation edge results.

In addition, a cement gap which is required for fixing the matrix to the tooth stump or the implant in the patient's mouth is taken into account if appropriate. The dental model is then modified such that a dental model which leaves space for positioning dental cement on the side facing the tooth stump or implant results.

In order to be able to fix the dental model on to a model support for subsequent working operations, corresponding recesses or protuberances are preferably provided in the dental model. These are threaded in construction, for example, so that screws fixed on the model support can engage directly into the dental model. Alternatively, the corresponding recesses are provided without a thread, so that dowels fixed to the model support can engage.

A process according to the invention which is furthermore preferred is one in which the dental model produced, for production of a three-membered bridge (for multiple-membered bridges the number of intermediate structural elements and of the support elements present is to be increased according to the missing teeth to be replaced) comprises: (i) two abutment structural elements which have a distance between them which corresponds to the distance between two teeth in the patient's dentition between which a (missing) tooth is to be bridged and (ii) at least one self-supporting intermediate structural element between the abutment structural elements which is connected to the abutment structural elements, if appropriate, and is electrically insulated from the abutment structural elements.

A dental model is created in this manner, and the matrix or the veneer for a bridge is produced on this in subsequent working steps. The caps are built on to the two abutment structural elements in further process steps. The two caps are those parts of the dental model which are placed on the teeth or the implants adjacent to the missing tooth or teeth in the patient's dentition.

In a preferred subsequent working step, a slip is added/deposited on to the intermediate structural element of the dental model, and the bridge intermediate member replacing the missing tooth is formed from this, again in subsequent working steps.

A preferred process is one in which the dental model produced comprises:
(i) two abutment structural elements which have a distance from one another which corresponds to the distance between two teeth in a patient's dentition between which at least one tooth is to be bridged and
(ii) for each tooth to be bridged, a hollow structure between the abutment structural elements which is electrically conductive on its inside and which is fixed to a model support, on which the two abutment structural elements are also fixed.

The hollow structure can be formed from two or more side shells. The hollow structure is advantageously electrically insulated from the two abutment structural elements. When the hollow structure is placed under a voltage in a subsequent working operation, slip is deposited on the inner surface and forms a slip layer, from which the veneer or the matrix for the intermediate members is formed in further working steps. The inner surface of the hollow structure has a contour which is shaped such that a dental moulding having the desired geometric dimensions is formed from the slip layer by subsequent working steps.

If the abutment structural elements are already generated during the production by rapid prototyping, an intermediate structural element which comprises electrically conductive substance is conventionally provided, so that the intermediate structural element is electrically conductive in areas of its surface. This intermediate structural element can comprise an individually formed platelet or a bar. When the intermediate structural element is removed (e.g. melted out) in the course of further process steps, a hollow cavity exists in the dental moulding formed. In order to influence the strength thereof as little as possible, the intermediate structural element is positioned such that the hollow cavity formed surrounds the neutral fibres of the dental moulding.

Alternatively, however, the intermediate structural element can also be introduced subsequently, after production of the model. For example, a metal film, a ceramic film with a metallic coating or a paper with a metallic coating, which are inserted between the abutment structural elements by means of a holder, can be used.

During heat treatment of the model in a subsequent working step—depending on the choice of material—the paper burns out, the ceramic film remains in the matrix and the metal burns out or is oxidized to an oxide and likewise remains as such in the matrix.

In order additionally to define the geometric shape of a bridge intermediate member, as an element of a dental moulding, formed in subsequent working steps with the aid of the dental model (having an intermediate structural element), additional borders are optionally built up at a defined distance around the intermediate structural element. When slip is deposited in a subsequent working step, the growing layer of slip is demarcated by this border, so that reworking can be omitted.

In a preferred process according to the invention, the rapid prototyping is carried out such that the dental model produced has a higher porosity in its inside than in its edge regions. In order to improve melting out, burning out or decomposition of the dental model during sintering of a ceramic layer applied to the dental model, it has proved desirable to produce the dental model with a higher porosity in its inside than on its surface. When the dental model is heated, the material initially expands. A further change in volume occurs during the solid/liquid phase transition. Any increases in volume are taken up by the pores, so that cracks in the ceramic layer applied to the dental model are minimized and even avoided.

A preferred process is one in which the dental model produced is electrically conductive in one or more regions of its volume and therefore of its surface. In such a model, an electrically conductive part of the surface is contacted electrically through the volume associated with this part. As a result, a large cross-section is available for conducting the electrical current, which leads to a low electrical resistance.

A preferred process is one in which the fluid, solidifiable materials to be employed (preferably having a melting point of below 250° C.) are photocurable and are preferably chosen from the group consisting of photocurable resins and photocurable waxes. In this case it is possible to produce the dental model by stereolithography, in which a photopolymer is applied in layers and is cured by means of UV light. By the use of the electrically conductive substance, a dental model produced in this way is also electrically conductive in one or more areas of its surface.

In a preferred process, the photopolymer resin comprises a monomer and a photoinitiator which absorbs in the range of the UV laser emission.

As already mentioned above, the object is furthermore achieved according to the invention by a dental model of the abovementioned type, which can be produced by a process described above.

As likewise already mentioned above, the object is furthermore achieved by a process for the production of a dental model with a ceramic layer deposited thereon.

The ceramic layer deposited can be readily worked mechanically with little wear on the tools employed while still in the moist state or optionally after drying. Thus, for example, the layer thickness of the cap or of the bridge can still be modified subsequently (e.g. by milling) and contours can be applied (e.g. by additional application of slip, also manually). The preparation edge, however, can moreover also be corrected.

A dental model which comprises one or more materials which are formed from a photocurable material by photocuring and/or which is conductive in one or more regions of its volume and, resulting therefrom, of its surface is favourable.

A preferred process for the production of a dental model with a ceramic layer deposited thereon is one in which in the case of electrophoretic and/or electrolytic deposition of the ceramic layer on one or more electrically conductive areas of the surface of the model produced, at least two conductive areas
(a) are placed under a voltage and/or connected without a voltage at different points in time and/or
(b) are placed under voltages which differ from one another

The invention also provides any desired combinations of voltages and periods of time during which the voltages are applied.

This process is suitable in particular for production of multiple-membered bridges. For the production of caps, on the other hand, advantageously only one electrically conductive surface is used.

The thickness of the ceramic layer which grows during electrophoretic and/or electrolytic deposition on the dental model can be controlled sensitively by the voltage and the duration with which the voltage is applied to the dental model. By the fact that different areas of the surface are placed under a voltage at different points in time, or are placed under different voltages and/or under a voltage for different lengths of time, ceramic layers of various thicknesses can be deposited at different points on the dental model. This is advantageous in particular if thicker ceramic layers are required for a bridge (in particular for intermediate members).

The object is additionally achieved according to the invention, as already mentioned above, by a process for the production of a dental moulding with the following steps:
production of a dental model with a ceramic layer deposited thereon by one of the abovementioned processes
working of the dental model with the ceramic layer deposited thereon, so that the ceramic layer is converted into a dental moulding.

The working here can be e.g. a sintering, dissolving out of the model, application of a ceramic slip, application of a binder, infiltration by glass and/or machining or the like. A sintering operation is often combined with an infiltration by glass, e.g. the strength of a superficially sintered ceramic part can be increased by infiltration by glass.

### BRIEF DESCRIPTION OF THE FIGURES

The invention is explained in more detail in the following with the aid of the attached drawing and with the aid of an embodiment example. The drawing shows:
FIG. 1 a longitudinal section of a dental moulding,
FIG. 2 a dental model,
FIG. 3 the dental model from FIG. 2 with an added-on ceramic layer in the region of the later intermediate member,
FIG. 4 a diagram of a dental model with a preparation shoulder and deposited ceramic layer and
FIG. 5 the dental model from FIG. 3 with an added-on, continuous ceramic layer.

### DETAILED DESCRIPTION

The invention is explained with the aid of the production of a dental moulding for a three-membered bridge restoration. The bridge restoration comprises an intermediate member which replaces a tooth which is no longer present, and two members which are each mounted on an abutment tooth, i.e. a first and a second abutment tooth.

An impression of the oral cavity of a patient is first taken. A silicone, alginate or polyether impression composition is as a rule employed for this. After the impression composition has hardened, the negative formed is cast with gypsum. The master model is produced from this positive. The master model (not shown) reproduces completely the situation in the mouth of the patient in the context of the impression accuracy.

A data model is created from this master model by scanning. A line scanner of the Speedscan type from BEGO GmbH & Co. KG is employed, for example, for this. The scan data obtained in this way are transmitted to a computer and displayed on a screen. The dental prosthesis is modelled on this data model by means of appropriate software. This is carried out with standard software from BEGO GmbH & Co. KG (SOFTSHAPE CAD software). The geometry of the data model is then enlarged such that a sinter shrinkage (e.g. of a ceramic cap) which occurs in the further process is compensated. The preparation line is additionally modelled on in the data model as a preparation edge. A cement gap is also modelled on in the data model. The cement gap is the space required for cementing the caps on the tooth stumps.

The porosity of the dental model is then specified. In this context, the porosity chosen for the inside of the dental model is greater, while the outer regions have no or a lower porosity.

The geometric shape of the ceramic bridge and the position thereof in the oral cavity of the patient are now calculated and the position and nature of the intermediate member can be specified by calculation. The forces which are to be expected when a corresponding ceramic bridge is used in the oral cavity are now simulated. For this, in the simulation typical compressive and shear forces are applied to the surface and the resulting forces in the ceramic bridge and the surface thereof are determined by means of the finite element method. The points on the ceramic bridge at which the highest forces are to be expected are thereby determined. In addition to the caps, this substantially applies to the intermediate member. It is then calculated whether the material thickness on the intermediate member and the connectors and also on the caps is sufficient to be able to accommodate the forces determined. If this is not the case, the data model of the cap is modified such that a greater material thickness is chosen in this point. The simulation calculation described is then carried out again with the modified data model. This iterative process is carried out until a geometry of the ceramic bridge which has the given strength is found.

After the geometric shape of the planned dental moulding 10 (cf. FIG. 1) has been specified by the (calculation) steps described above, the data model of the planned dental moulding existing on the basis of STL data and therefore of the dental model to be produced in the rapid prototyping process is modified in a further calculation step such that the sinter shrinkage is compensated. Three (in the present embodiment example) electrically conductive areas on the surface of the future dental model and the particular contacting thereof are then specified.

The data model is then printed out three-dimensionally on a 3D printer of the T66 type from Solidscape, Inc., Merrimack, USA. During inkjet printing, small beads of liquid material are released by a print head on to the workpiece being formed and solidify there and build up the dental model. The porosity of the dental model is adjusted according to the data model by the density of the beads released.

(a) An electrically insulating wax and (b) a wax which has been rendered electrically conductive with carbon black particles are used for production of the dental model. In the embodiment example, an electrically non-conductive wax from the manufacturer Solidscape is employed as the first print material. This wax has a melting point of 54 to 76° C. and is not provided with a conductive substance. Wax from the manufacturer Solidscape which has been mixed in a weight ratio of 10:1 with carbon black (Printex XE2, Degussa AG having a CTAB surface area of 600 m²/g) is employed as the wax which has been rendered electrically conductive with carbon black particles. This results in a wax/graphite mixture having a specific electrical resistance of approx. 1 Ωm. It goes without saying that the conductive wax defines electrically conductive regions of the finished dental model. FIG. 1 shows a finished dental moulding 10 of a three-membered bridge in longitudinal section view. The dental moulding 10 comprises a matrix 12 and a veneer 14. An intermediate member 16 lies here between a first corner member 18 (on the left in the drawing) and a second corner member 20 (on the right in the drawing) and is connected to the two by connecters 11a, 11b. The corner member 18 is mounted on an abutment tooth drawn in here as a dotted line (left), and the corner member 20 is mounted on an abutment tooth likewise drawn in as a dotted line (right). The intermediate member 16 replaces a tooth which is no longer present. The dental moulding was produced by the process described in the following.

FIG. 2 shows a diagram of a finished dental model 24, which comprises a first abutment structural element 25 in the region of the left-hand corner member 18 (cf. FIG. 1). The abutment structural element 25 in turn comprises a first insulating section 21 and an electrically conductive section 22. The insulating section 21 has been printed out from insulating wax and the conductive section 22 has been printed out from conductive wax. An electrically conductive area 26 extends along the surface of the electrically conductive section 22. The abutment structural elements correspond in their proportions at least substantially to the stumps of the abutment teeth shown as dotted lines in FIG. 1.

The dental model 24 furthermore comprises an intermediate structural element 19 in the region of the intermediate member 16 (cf. FIG. 1). An electrically conductive area 28 extends over the surface of the intermediate structural element 19.

Finally, the dental model 24 comprises a second abutment structural element 17 in the region of the right-hand corner member 20 (cf. FIG. 1), which comprises an electrically conductive section 27 and an electrically insulating section 15. An electrically conductive area 30 extends over the surface of the electrically conductive section 27.

The electrically conductive areas 26, 28 and 30 are areas of the surface of the particular associated electrically conductive sections 22, 23 and 27 and in the present case are conductive due to the conductivity of the electrically conductive sections 22, 23 and 27 themselves. In an alternative embodiment, the sections 22, 23 and 27 are non-conductive and merely have a thin layer of electrically conductive substance on their surface. The thickness of the electrically conductive surface areas 26, 28, 30 is approx. 0.2 mm to 1 mm in this case. In both cases the electrically conductive areas 26, 28, 30 have no porosity in the context of production accuracy.

The three electrically conductive areas 26, 28 and 30 (identified in FIG. 2 by different hatching) are electrically insulated from one another. Between the conductive area 26 and the electrically conductive area 28 there is an electrical insulation 29, and between the electrically conductive areas 28 and 30 there is a further electrical insulation 31.

When the dental model 24 is printed out, preparation edges 35a, 35b, 35c, 35d are provided on the basis of corresponding settings from the data model, which have been modelled on there in a prior working step. Furthermore, holes 32, 33, 34 are recessed into the insulating sections 15, 21, into which the dowels or electrodes engage. In the dental model 24 shown in FIG. 2, a first electrode 36 is provided, which engages into the hole 32 and contacts the electrically conductive area 26 of the abutment structural element 25 via a conductor 37. A second electrode 38 engages into the hole 33 and contacts the electrically conductive area 28 of the intermediate structural element 19 via a conductor 39, and a third electrode 40 correspondingly contacts the electrically conductive area 30 of the abutment structural element 17 via a conductor 41.

The dental model is fixed via dowels, which are not drawn in here, of which one engages into a recess 48 and a further one engages into a recess 50, to a model support, which is likewise not drawn in. The production of the dental model is thus concluded.

For production of a dental moulding, the dental model 24 fixed to a model support is dipped in a slip bath such that the electrodes 36, 38, 40 do not come into contact with the slip.

A voltage is applied between the second electrode 38 and a slip bath electrode 54, which contacts the slip bath, which is not drawn in here, so that a defined current flows. In the present case, a stabilized mixture of ethanol and aluminium oxide powder is used as the slip. A suitable liquefying agent for aluminium oxide is polyacrylic acid, which causes high charging of the particles and at the same time assumes the function of a binder.

By application of the voltage, a layer of slip is deposited on the electrically conductive area 28 (FIG. 3). The layer thickness depends here in particular on the electric charge which has flowed, the slip material chosen and the size of the surface of the electrically conductive area 28. The layer thickness of the slip layer is the same size here at each point of the electrically conductive area 28. The size of the surface is calculated from the data model. The charge which has flowed is the product of the electrical current measured and the time measured during which this current has flowed. If the surface area and the electrical current are known, the time after which a ceramic layer of the desired thickness has been deposited can therefore be calculated or at least estimated. This time is up to a few minutes. After this time, the flow of current is interrupted. A dental model with such a ceramic layer 46 is shown in FIG. 3.

The other two electrically conductive areas 26, 30 are then contacted at the same time and ceramic layers are deposited on them in the same manner. A uniform ceramic layer, namely the later matrix, is formed by the particular ceramic layers merging.

Alternatively, ceramic is first deposited simultaneously on all the electrically conductive areas 26, 28, 30, although e.g. the voltage can remain applied for longer in area 28 in order to produce a particularly thick ceramic layer.

For the layer thickness and the form of the ceramic layer to be subsequently increased or modified further, additional slip can be applied manually. The dental moulding thus acquires the desired and characteristic form and at the same time the transmitting force to be withstood is increased.

Since no tooth which supports the bridge is present in the region of the intermediate member, in the normal case greater elastic deformation of the bridge restoration occurs in this region during chewing. To avoid this, a thicker ceramic layer is chosen (as shown) above all for the connectors 11a, 11b and the deformation is thereby reduced. The two ceramic layers deposited last therefore have a lower layer thickness than that deposited first.

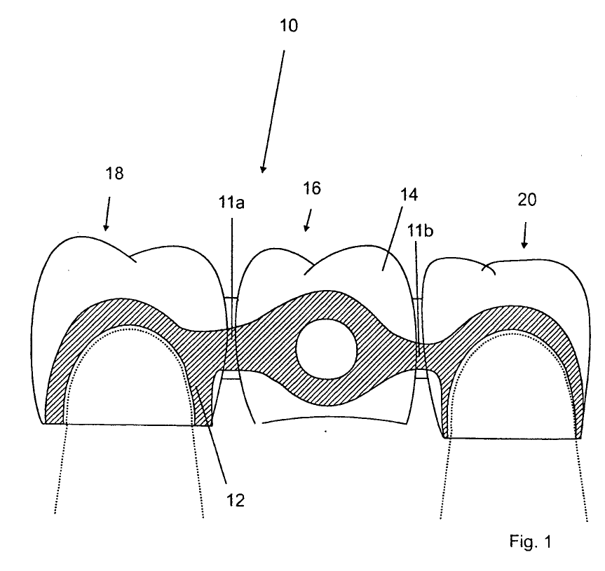

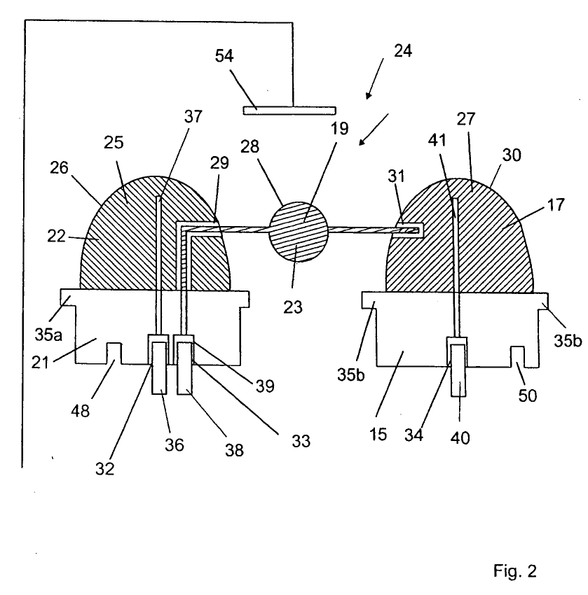

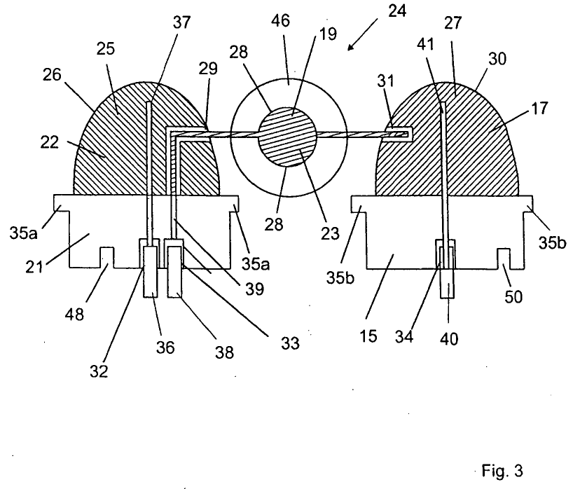

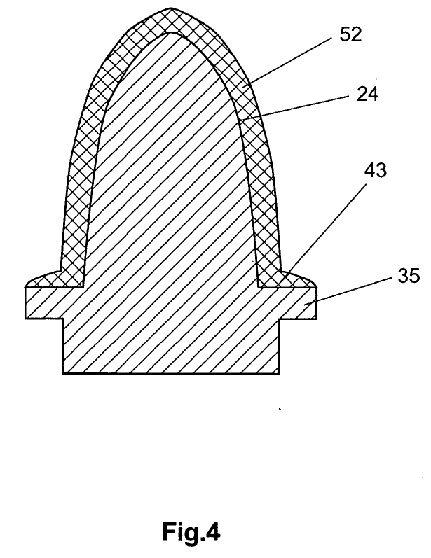

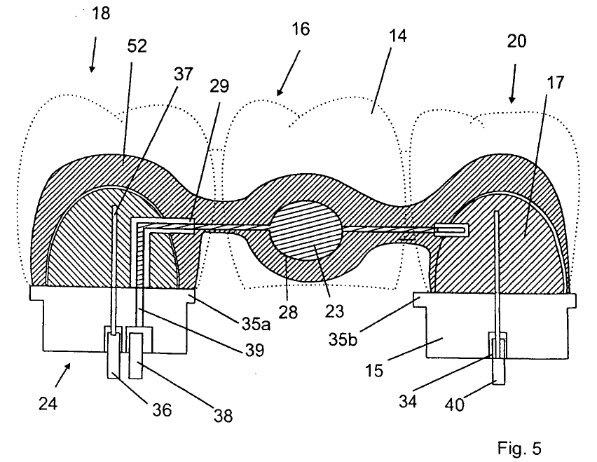

The ceramic caps often have a layer thickness of <0.8 mm in the region of the corner members 18 and 20, while in some cases the ceramic in the region of the intermediate member 16 is several millimetres thick. FIG. 5 shows a ceramic layer 52 which has merged on the dental model 24 from which the cap is formed in the course of the subsequent working steps. The ceramic layer 52 which has merged has, in contrast to what is shown in the figure, a layer thickness which is the same at every point.

The dental model 24, together with the deposited, merged ceramic layer 52, is removed from the electrophoresis device. The green compact from the merged ceramic layer 52 is subsequently reworked by milling. During this procedure, the ceramic green compact is ground back in a defined manner at the preparation edge with a milling cutter or a grinding apparatus. FIG. 4 shows a diagram of a dental model 24 with a ceramic layer 52 deposited thereon, which ends at a preparation edge 35. A projection 43 is removed for the finishing.

FIGS. 2 and 3 show preparation edges 35a, 35b for the members of the dental model shown there. Preparation edges (preparation boundaries) can be drawn out in a defined manner and clearly as a shoulder. The demarcation of the dental moulding (e.g. cap) in the vertical direction is thus also to be detected visually after the coating. Underneath the shoulder, as shown in FIG. 4, is the foot of the tooth stump. This foot of the stump is so thick, for example, that the extension corresponds to the area of the resulting surface from the layer thickness and stump. When the shoulder is ground down to the lower surface of the preparation edge 35, the defined working of the cap in the horizontal direction takes place at the same time.

A dental moulding (cap or bridge) can be machined to the required preparation line together with the dental model (e.g. wax model). For this, the data file is preferably processed such that e.g. holes for e.g. dowels are formed at defined points on the under-side of the dental model, or the under-side is formed such that it fits in a defined manner into a mould which accommodates the model. The dental model produced in this way can then be locked together with the ceramic layer in a device with a milling cutter, which can then follow the contour with the aid of already existing data. By this route, for example, it is possible to produce a ceramic abutment, which is fixed to an implant. For this, the surface of the veneer is created by means of milling according to precisely defined geometries.

The green compact finished in this way is heated to 150° C. on the dental model in an oven. This is carried out in a powder bed. During this operation, the green compact dries and the wax (having a melting point of 54 to 76° C.) melts out. Incipient cracks in the green compact can be largely avoided by the porosity introduced inside the dental model during rapid prototyping, in combination with the powder bed. The green compact is subsequently subjected to final sintering at 1,300° C. to 1,700° C., so that a finished dental moulding is formed. The sinter shrinkage which thereby occurs has been taken into account during creation of the dental model, as described above, so that the dental moulding formed fits the master model with a high accuracy.

Burning out of the model and the subsequent sintering are preferably carried out in a powder bed. If the coated wax model is merely placed on a burning-out base, stresses may arise in the green compact as a result of non-uniform melting and burning out of the model. However, since this is the state in which the ceramic layer has the lowest strength, it can lead to cracks. This can be prevented by introducing the electrophoretically coated model into a powder bed. As a result, stresses and therefore destruction as a consequence of gravity and non-uniform burning away of the model do not occur. The powder bed therefore has the following tasks: a) the powder bed supports the component uniformly, b) the powder bed sucks up the wax and carries it away better.

One possibility of increasing the strength of the ceramic layer so that it survives the process step of thermal dissolving out of the model undamaged is the use of a binder. This can already be added to the slip, or it is preferably introduced on to the dried matrix.

### EMBODIMENT EXAMPLE

### Production of a Cap or a Crown (Dental Moulding)

A master model of an individual tooth preparation is provided. This is scanned in and the data obtained are processed on the PC. During this procedure, the volume of the model to be produced is increased according to the decrease in volume during sintering, i.e. the sinter shrinkage is compensated. A cement gap which is required for cementing the caps on to the tooth stumps is taken into account when designing the geometry required. Furthermore, the preparation line is drawn out clearly as a preparation edge.

The data model is designed such that a dense, 0.2 mm thick surface of the dental model is formed during the rapid prototyping, whereas the inner volume of the dental model is built up as a porous support structure. The data model based on STL data is then converted into a dental model via the rapid prototyping (printing) process. For this, (a) an electrically insulating wax and (b) a wax which has been rendered electrically conductive with carbon black particles, such as are described above, are employed. The areas are demarcated by the preparation edge.

Alternatively, the dental model is produced from the data model by stereolithography. In this context, in each case an electrically conductive polymer is applied in layers and cured by means of UV light. An apparatus from 3d-Systems of the SLA 7000 type e.g. is employed for this.

The electrically conductive area of the finished dental model is contacted and dipped, together with a counter-electrode, into a slip bath comprising the slip described above.

After application of a voltage, a ceramic layer is deposited in a finished form after a few seconds up to some minutes, depending on the desired layer thickness and the current flow set and the voltage.

The ceramic green compact produced in this way is dried together with the dental model. The ceramic green compact of the cap is ground back in a defined manner at the preparation edge using a milling cutter or a grinding apparatus. Additional slip can optionally be applied to modify the contour. The model is then separated out thermally. This is carried out at temperatures of between 54 and 76° C., since the melting point of the wax is already reached here. Residues of the wax which have not flowed out due to wetting burn without residue during the further increase in temperature. Alternatively, the model can be dissolved out chemically.

Sintering of the green compact is carried out at temperatures of from 1,300° C. to 1,700° C. The ceramic particles of the green compact sinter together, so that a decrease in volume occurs. This decrease in volume has been taken into account beforehand, see above. The ceramic matrix is subjected, for example, to dense sintering or superficial sintering. Glass is additionally infiltrated in to increase the strength.

The ceramic cap obtained or the crown obtained (dental moulding) fits the master model and therefore the tooth preparation with a high accuracy. It has a high density of more than 90% and therefore has a high strength. It cannot be and is not subsequently infiltrated by glass.

As an alternative to the dense sintering at high temperatures described for the ceramic cap (dental moulding), the green compact can be superficially sintered at temperatures of between 1,000 and 1,300° C. This is associated with only a low decrease in volume, but also a remaining high porosity. This porosity can be filled up by glass infiltration in a subsequent step. Since the decrease in volume is only low, in this alternative procedure the volume of the dental model to be produced is also increased only slightly compared with that of the master model.

1. Process for the production of a dental model (24) with the following steps:
providing a fluid, solidifiable material and an electrically conductive substance,
producing the dental model (24) by rapid prototyping using the fluid, solidifiable material and the electrically conductive substance, so that the dental model produced is electrically conductive in one or more areas (26, 28, 30) of its surface.

2. Process according to claim 1, characterized in that the dental model (24) is produced by stereolithography and/or 3D printing of the fluid, solidifiable materials and of the electrically conductive substances.

3. Process according to claim 1, characterized in that the fluid, solidifiable material is chosen from the group consisting of wax and plastic.

4. Process according to claim 1, characterized in that graphite, carbon black and/or metal particles are used as the electrically conductive substance.

5. Process according to claim 1, characterized in that at least one electrically conductive substance is mixed with at least one fluid, solidifiable material before use thereof in rapid prototyping.

6. Process according to claim 1, characterized in that the dental model (24) produced is electrically conductive in at least two areas (26, 28, 30) of its surface which are electrically insulated from one another.

7. Process according to claim 1, characterized in that the electrically conductive substance comprises a second fluid, solidifiable material.

8. Process according to claim 1, characterized in that a data model containing geometric data of the dental model which is obtained by intraoral scanning, by scanning a working model or by scanning a master model are used for the rapid prototyping.

9. Process according to claim 8, characterized in that the data model is modified before production of the dental model such that an over-dimensioned dental model results, in order to compensate for the change in dimensions to be expected on a dental moulding blank formed by casting from the dental model during its production process.

10. Process according to claim 8, characterized in that, before production of the dental model, the data model is modified on the basis of a numerical calculation of the local failure probability of a dental moulding blank formed by casting from the dental model such that a preselected local failure probability is exceeded nowhere on the dental moulding blank formed.

11. Process according to claim 8, characterized in that before production of the dental model, the data model is modified such that after production by rapid prototyping a dental model results which (i) has a projection at a point which corresponds to a point at which the dental model has a preparation edge (35a, 35b, 35c, 35d) and/or (ii) which has one or more recesses (48, 50) or protuberances for accommodation of fixing means for fixing the dental model (24) to a model support

12. Process according to claim 1, characterized in that the dental model (24) produced comprises:
(i) two abutment structural elements (17, 25) which have a distance from one another which corresponds to the distance between two teeth in a patient's dentition between which at least one tooth is to be bridged and
(ii) for each tooth to be bridged, a self-supporting intermediate structural element (19) between the abutment structural elements (17, 25) which is electrically insulated from the abutment structural elements.

13. Process according to claim 1, characterized in that the dental model produced comprises:
(i) two abutment structural elements which have a distance from one another which corresponds to the distance between two teeth in a patient's dentition between which at least one tooth is to be bridged and
(ii) for each tooth to be bridged, a hollow structure between the abutment structural elements which is electrically conductive on its inside and which is fixed to a model support on which the two abutment structural elements are also fixed.

14. Process according to claim 1, characterized in that the rapid prototyping is carried out such that the dental model (24) produced has a higher porosity in its inside than in its edge regions.

15. Process according to claim 1, characterized in that the dental model (24) produced is electrically conductive in one or more regions of its volume and of its surface.

16. Process according to claim 1, characterized in that the fluid, solidifiable materials are photocurable and are preferably chosen from the group consisting of photocuring resin and photocurable wax.

17. Dental model comprising one or more solidified materials, and one or more electrically conductive substances in one or more areas of its surface, characterized in that said model is produced by a process according to claim 1.

18. Process for the production of a dental model with a ceramic layer deposited thereon, with the following steps:
producing a model (24) which is electrically conductive in one or more areas of its surface by rapid prototyping by a process according to claim 1,
depositing a ceramic layer on one or more electrically conductive areas (26, 28, 30) of the surface of said model (24).

19. Process according to claim 18, characterized in that the depositing step comprises electrophoretic and/or electrolytic deposition of the ceramic layer on one or more electrically conductive areas of the surface of the model produced, wherein at least two conductive areas
(a) are placed under a voltage and/or connected without a voltage at different points in time and/or
(b) are placed under voltages which differ from one another

20. Process for the production of a dental moulding (10), with the following steps:
production of a dental model (24) with a ceramic layer (46; 52) deposited thereon, according to claim 18, and
working the dental model (24) with the ceramic layer (46; 52) deposited thereon, so that the ceramic layer is converted into a dental moulding.

21. A process for the production of a dental model (24) with the following steps:
providing a fluid, solidifiable material and an electrically conductive substance through a 3D printer having at least two print systems,
producing a dental model (24) which comprises one or more solidified materials and which comprises one or more electrically conductive substances in one or more areas (26, 28, 30) of its surface.

22. A kit comprising (a) a first 3D printer modelling cartridge containing one or more fluid, solidifiable or fluidizable and re-solidifiable materials, and (b) a second 3D printer modelling cartridge containing one or more electrically conductive substances, said kit being adapted for use in a rapid prototyping process according to claim 21.
